(19) United States
(12) Patent Application Publication
(10) Pub. No.: US 2006/0033499 A1
(43) Pub. Date: Feb. 16, 2006

(54) Receive system for high q antennas in nqr and a method of detecting substances

(76) Inventors: John Harold Flexman, Kardinya (AU); Peter Alaric Hayes, Wembly Downs (AU); Warick Paul Chisholm, Ferndale (AU); Vassile Timofeevitch Mikhaltsevitch, St James (AU); Taras Nikolaevitch Rudakov, Villetton (AU)

Correspondence Address: PILLSBURY WINTHROP SHAW PITTMAN LLP, 1650 TYSONS BOULEVARD, MCLEAN, VA, 22102, US

(21) Appl. No.: 10/517,627

(22) PCT Filed: Jun. 13, 2003
(86) PCT No.: PCT/AU03/00737

§ 371 Date: Sep. 7, 2005

(30) Foreign Application Priority Data
Jun. 13, 2002 (AU) PS 2950

(51) Int. Cl. G01V 3/00

(52) U.S. Cl. 324/322; 324/318; 324/307

(57) ABSTRACT

A receiving system (11) for connection to an antenna arrangement (19) for detecting response signals from a substance having quadrupolar nuclei excited so as to produce nuclear quadrupole resonance in certain of the quadrupolar nuclei. A method for receiving a response signal via the antennae arrangement (19) is also described. The receiving system (11) includes an amplifier (17) to amplify the received response signal from the antenna arrangement (19) for subsequent processing, a matching section (15) to match the amplifier (17) to the antenna (19), and an isolating switch (13) to isolate the antenna from the receiving system (11). The matching section (15) noise matches the receiving system (11) to the antenna (19) during a receiving period to reduce the Q factor of the antenna without significantly degrading the signal to noise ratio. The isolating switch (13) isolates the receiving system (11) from the antenna (19) during a transmitting period when an excitation signal is transmitted by the antenna (19) to irradiate the substance. It also electrically connects the receiving system (11) to the antenna during the receiving period immediately after the transmitting period.

### FIELD OF THE INVENTION

The present invention relates to Nuclear Quadrupole Resonance (NQR) spectroscopic devices and methods of detecting using such devices. More particularly the invention relates to those devices that require extended bandwidth, phase-stability or reduced Q factor during reception of a response signal sourced from a substance containing quadrupolar nuclei that are appropriately excited. These devices typically contain a high Q resonant circuit antenna that is designed to intercept magnetic field variations and convert them to output voltages to be amplified, so that the NQR response signal may be recorded.

Throughout the specification, unless the context requires otherwise, the word “comprise” or variations such as “comprises” or “comprising”, will be understood to imply the inclusion of a stated integer or group of integers but not the exclusion of any other integer or group of integers.

### BACKGROUND ART

The following discussion of the background art is intended to facilitate an understanding of the present invention only. It should be appreciated that the discussion is not an acknowledgement or admission that any of the material referred to is or was part of the common general knowledge as at the priority date of the application.

The NQR response signal is used to identify nuclei having a quadrupole moment in specific chemical environments. The frequency of excitation producing such a response signal depends on the interaction between the electric field gradient created by the electronic charge distribution around the nucleus and the electric quadrupole moment of the nucleus. The charge distribution relates directly to the nature of chemical bonds at that molecular site. The ability to apply the NQR technique to the detection of explosives and contraband narcotics has largely occurred because of the properties of the ¹⁴N isotope. The received NQR response is directly proportional to the quantity of such nuclei and fortunately the abundance of ¹⁴N in illicit substances is relatively high.

The ¹⁴N isotope has a nuclear spin of 1, and possesses a quadrupole moment that, depending on the chemical environment, will resonate in an applied radio frequency (RF) field. The application of NQR is not limited to this one isotope, as there are many other quadrupolar nuclei that have been used in material identification. The technique of excitation is, however, essentially the same. The excitation frequency is discrete, most substances of interest having values in the range from 100 kHz to 30 MHz.

The excitation proceeds through a series of RF pulses applied to an antenna that is close to the sample. This series of RF pulses is referred to as a pulse sequence. The fluctuating RF field at the appropriate excitation frequency drives the rotation of the nuclei in a coherent fashion, so that the magnetic field from this synchronised nuclear rotation will be received. The receiving antenna or antennae, which may be the same as the driving antenna or antennae, will pick up an induced signal voltage proportional to the time derivative of this magnetic field. The problem is how to excite and receive this signal in optimal ways to obtain the maximum Signal-to-Noise-Ratio (SNR). Typically the received signals are several orders of magnitude less than the driving signal, and less than or similar in magnitude to the thermal noise produced by the antenna system.

To extract the NQR signal, receive antennae are constructed to intercept as much of the sample magnetic field as possible, forming an inductive element L. This element of the antennae is usually made resonant to improve the signal to noise ratio by including an appropriate parallel capacitance C. This electronically resonant circuit, or tank circuit, will store energy from the sample at or close to a resonant angular frequency (ω₀), preferentially increasing a coherent source's signal relative to incoherent sources eg. thermal or spurious noise. The rate at which this energy is dissipated determines the SNR and can be represented by the Quality factor (O) of the circuit. Resistive losses do occur within the circuit and to the environment around the antennae including the sample. The entire circuit can be modelled as having three parallel components, L, C and R where R represents those resistive losses. Q at resonance can be calculated from:
Q=R/(ω₀L)=R ω₀C,
where ω₀=(LC)^{-1/2}, ω₀ is related to the tuned frequency f₀ by ω₀=2 πf₀.

For a continuously received signal the voltage SNR can be shown to be proportional to Q^{1/2}: Clearly a high Q factor is extremely desirable for good SNR for this typical antenna. This can be achieved by minimizing resistive losses within the antenna and lightly coupling the electronics needed to amplify the resonant signal. For an optimum antenna, the value of Q would be at least 200 during the receive part of the excitation sequence.

Prior art as shown in FIG. 1, would typically incorporate a ¼ wave isolating element that uses back-to-back diodes to set a node at the amplifier during transmit. The amplifier has typically 50 ohms input impedance and would be configured to allow maximum signal power transfer. The isolating element protects the 50 ohm impedance amplifier, and maintains the Q of the antenna alone during the transmit part of the sequence. Once the signal level from the antenna drops below the diode's forward voltage, the amplifier is connected to the antenna.

There are, however, several deficits with employing a high Q antenna.

(1) The stored energy remains in the antenna for a long period after the driving signal has been removed. Until this energy is removed the receiver system will tend to be saturated by the induced ringing voltages, causing a significant dead-time between the applied pulse and commencement of the receive period. The ring down time constant τ for this exponentially decreasing signal can be calculated from:
τ=2Q/ω₀.

A high Q circuit typically will have a ring-down time of several milliseconds for excitation frequencies around 1 MHz. This induces large dead-times and forces the character of the pulse sequences to be instrumentally determined. The extended time leads to less signal intensity being intercepted during a fixed receive period and a less effective pulse sequence. The extended time can also lead to a rapidly varying frequency response for the sample due to the addition of the Fourier components of the multiply pulsed transmit signal.

A solution to this problem is to include a “Q-switch”, which can be controlled to switch a low impedance across or partially across the tank circuit for a short period before the receiving process has begun. This is shown schematically in FIG. 2. The lower impedance absorbs energy out of the tank circuit more rapidly, consequently lowering the Q. The use of a switch invariably induces a transient pulse during the turning off period through parasitic or semiconductor junction capacitances. Q-switching can also be performed by using semiconductor devices, which once switched have a self-recovery period to high impedance. These devices can suffer from self-triggering given a high enough dv/dt or voltage amplitude.

(2) Small instrumental drifts or mistakes in tune frequency or Q can cause both amplitude and phase variations because of rapid changes in antenna reactance close to resonance. Apart from instrumental errors, in a detection application often the exact NQR frequency is not known precisely. As a consequence the phase stability of the receiver system is poorer in a high Q system.

In the modelled tank circuit described above, the impedance for small frequency and inductance shifts is approximated by:
Z=R+2iL(ω−ω₀),
where i represents a complex number, R is the real impedance at resonance, L is the value of the inductance and the term in brackets represents the frequency shift in radians.

This equation shows at resonance the impedance is resistive, but away from this point the load appears increasingly reactive. This increasing reactance will shift the phase of an applied magnetic field during the transmit phase and again when the magnetic field from the signal source(s) is received through the antenna.

Phase shifts in the antennae from the ideal situation can be introduced from several sources. The lifetime of an NQR state spreading the signal over a frequency range would be one source. Similarly, the vibration and/or small deformation of the antenna, thermal drift of inductive and capacitive elements, the movement of a sample near the antennae, the antenna not being tuned properly due to the constituents of scanned objects, and temperature changes inducing a frequency shift in the NQR signal, would all be examples of other sources.

A predetermined phase interval, or phase weighting scheme is often used as part of the procedure in identifying the substance signal and to discriminate it from other signal sources. This method limits the ultimate detection rate and false alarm rate. In order to maintain this phase information due to the substance alone, it becomes important to reduce the apparatus' sensitivity to these other potential sources.

(3) The bandwidth of a high Q system will be narrower than a lower Q system, as can be seen from the definition of a 3 db bandwidth for the modelled system:
Δf_{3db}=f₀/Q.

The 3 db range corresponds to the frequency interval over which a signal can be received with a power of at least 50% from the maximum value. A reduction in bandwidth for a single narrow frequency NQR signal will not affect the received signal at the correct tuning point. The signal in such an ideal case would lay at the maximum of the antenna response with frequency.

The sample's NQR frequencies however may not be accurately known. For example, in spectroscopic work, many NQR states are yet to be determined. In detection work, perhaps the biggest source of uncertainty comes from the temperature of the sample not being precisely known in the substance to be found. The frequencies of most NQR lines depend on the sample temperature as it affects the average electric quadrupole moment from the electronic distribution. Movement of the NQR frequency for a single transition will be approximately described by a temperature coefficient. For a high Q antennae system the received signal will be considerably reduced in amplitude as the NQR frequency drifts away from the tuned frequency. A range of frequencies therefore needs to be received for an effective detector.

Substances to be detected may be composed of several chemicals. Within each chemical structure there will be several NQR modes for the contained quadrupolar nuclei. Each of these variations introduces a particular series of identifying NQR frequencies. For example the explosive TNT has 2 groups of 6 lines that fall within 30 kHz at room temperature. It would be advantageous to detect as many of these resonance excitation frequencies simultaneously to aid in the identification. For a high Q system, it would generally only be possible to efficiently receive one line at a particular tuning point.

Without going into detail, excitation frequencies and received frequencies generally are not exactly the same in a typical pulse sequence. This is called an off-resonance excitation. Where a detection system employs high Q transmit and receive antennae tuned to a single frequency there will be a reduction in performance due to this offset.

In the related fields of NMR and MRI, methods that counteract the effects of points (1), (2) and (3) for antennae without sacrificing the SNR have been sought to provide a practical working device. In one of these methods, a negative feedback amplifier was employed to lower the presented impedance of the amplifier. It was recognized, however, that a system employing feedback resistance would introduce unacceptable thermal noise or high input capacitance from a large value resistor, whereas a system employing capacitive feedback would not. This idea has been extended to include a capacitive divider or network in the feedback to the input, which does reduce the effective feedback resistance seen at the input of the amplifier, hence helping to maintain a good SNR. The circuit configuration is shown in FIG. 3.

The problem with this technique, however, is that it is difficult to match to a given antenna. The technique does not give optimum receiver bandwidth or the best properties of a constant receiver phase across a temperature range of an NQR signal. Furthermore, the use of capacitance in the feedback loop, which may not be convenient in a commercial amplifier, introduces the possibility of high frequency oscillation modes, which may obscure the NQR signal.

### DISCLOSURE OF THE INVENTION

Pursuant to the present invention, a different way of viewing the problem of providing an optimum NQR receiver system is to achieve close to optimal wide bandwidth operation at a given temperature. Over this bandwidth the SNR is approximately the same as the antenna alone. In providing this bandwidth, the device will necessarily achieve a low Q, and mitigate points (1), (2) and (3).

It is an object of the present invention to provide for improved NQR detection compared with the prior art described above, and which is relatively easy to implement.

In accordance with one aspect of the present invention, there is provided a receiving system for connection to an antenna arrangement for detecting response signals from a substance having quadrupolar nuclei excited so as to produce nuclear quadrupole resonance therein, the system comprising:—
an amplifier to amplify the received response signal for subsequent processing; and
a matching section to match the amplifier to the antenna;
wherein the matching section noise matches the receiving system to the antenna during a receiving period and reduces the Q factor of the antenna without significantly degrading the signal to noise ratio.

Preferably, the matching section presents an effective lower impedance to the antenna. This provides for optimum reception bandwidth and reduced phase errors.

Preferably, the matching section comprises a damping means to damp stored transmitter energy from the antenna, without effecting further switching or configuration changes.

Preferably, the receiving system includes isolating means to isolate the antenna from the receiving system; the isolating means including switching means to isolate the receiving system from the antenna during a transmitting period when an excitation signal is transmitted by the antenna to irradiate the substance, and to electrically connect the receiving system to the antenna during the receiving period immediately after the transmitting period.

In this manner, the system can adopt the cycle of maintaining a high Q on the antenna during the transmitting period, followed immediately by a low Q during the entire receiving period for any data gathering transmit signal pulse sequence in the field irradiating the substance. Thus the high Q phase allows power delivery into the antenna for efficient excitation over a frequency band, and the low Q during the receiving period allows the system to measure signals close in time to the excitation transmit signal pulse. This consequently enables a fast accumulation of the signal to its maximum amplitude, broader frequency bandwidth to receive a signal or several signals and vastly improved received signal phase stability. All these features allow for better dynamic SNR measurements during the data collection phase and better selection of a true response signal from other competing signals such as those arising from magneto-acoustic objects or thermal noise.

Preferably, the isolating means is interposed between the antenna and the matching section to block the high voltage that may be generated on the antenna during the transmitting period. These voltages may have amplitudes of several kilovolts. In such an environment of high voltages, it is preferred that the isolating means includes ¼ wave lines terminated with back to back diodes to provide isolation, in combination with nodes being set close to the amplifier by protection diodes. Alternatively, the isolating means may operate through a pi-network that is equivalent to a ¼ wave line in operation, terminated with back-to-back diodes. In this configuration, the system therefore relies on the frequency to be determined making the system dependent on the investigated NQR line.

Alternatively still, the isolating means may operate on a change of inductance from a high value to a low value of impedance during the switching process, the low value of the isolating means having impedance that is less than the characteristic input impedance of the matching section.

Preferably, the isolating means is auto-switching, triggered by monitoring electronically an increase or decrease in input signal level beyond a threshold level.

Alternatively, the isolating means may be auto-switching, triggered by a second input that monitors electronically an increase or decrease in signal from the transmitter unit output.

Preferably, the isolating means is triggered by a reproducible electrical signal which is synchronised to the transmit sequence.

Preferably, the switching means has opening and closing characteristics shaped in time.

Preferably, the switching means is not frequency dependent over the general range of NQR lines of interest. Such an apparatus would be useful in investigating several distinct lines in the NQR response from a substance, whether this is from the broadened bandwidth or the same receiving apparatus coping with an antenna that is tuned to other resonance frequencies, or a multiply tuned receiving antenna.

After the isolation means, the receive system is preferably followed by a low Q signal receive circuit that reduces energy in the antenna and remains in the low Q state during the entire receiving period. In this manner, energy contained within the antenna after the excitation transmit signal pulse, is removed rapidly by the apparent low impedance of the following receiver system. This state is maintained throughout the receiving period.

Importantly, the low input impedance does not add significant thermal noise to the signal, the matching section preferably being constructed from high figure-of-merit transistors to create a close to ambient temperature thermal noise match to the antenna. In such an arrangement, the presented impedance at the mid-band of the antenna can be thought of as an effective cold resistor, having a resistance given by the input impedance and having an effective temperature that would generate the same thermal noise power.

The time taken to remove this energy from the antenna depends exponentially on the input impedance after the isolator. Some applications may require increased Q damping beyond what is available with a correctly noise matched receiving system. In these cases, it is preferred that an additional low impedance, low voltage high-speed semiconductor switch is included after the isolation means to function as a damping switch. This damping switch preferably has predetermined transition rates so as not to re-excite the antennae through parasitic capacitance or changes in state.

Preferably, the damping switch is transistor based and is included at the input of the matching section to controllably lower the input resistance to signal ground, the damping switch being driven by a pulse synchronised to the transmit sequence.

In one arrangement of the damping switch, it is preferred that the damping switch is based on a FET or parallel FETs pulse triggering the gate or gates.

In an alternative arrangement of the damping switch, it is preferred that the damping switch is based on a MOSFET or parallel MOSFETs where the source and drain are connected from the signal input to ground, and that a pulse to the gate triggers the damping switch.

Preferably, the turning on and off characteristics of the damping switch are controlled through time.

In one embodiment of the matching section, it is preferred that the transistors are JFETs arranged in parallel source and drain connections with their gates at signal ground.

In another embodiment of this arrangement of the matching section, the transistors comprise a plurality of JFETs arranged in a cascode arrangement with a negative feedback circuit.

In one configuration of the cascode arrangement of JFETs, it is preferred that bipolar transistors are provided at the source connection of the JFETs.

Preferably, the negative feedback circuit is equivalent to a cold resistor.

Preferably, the negative feedback circuit is a capacitor or inductor combination.

Preferably, the negative feedback circuit is resistive with most of the fed-back current being conveyed away from the signal input to signal ground through a capacitive or inductive divider.

Preferably, the bandwidth of the matching section is limited in gain by a tuned circuit. It is preferred that in this arrangement, the chosen bandwidth would typically lie in a range from 1 kHz to 200 kHz.

Preferably, the amplifier is of negative feedback with a low noise figure.

Preferably, the voltage is fed-back through a negative feedback circuit that is equivalent to a cooled resistor.

Preferably, the feedback circuit is resistive with most of the fed-back current being diverted away from the signal input through a capacitive or inductive divider.

Preferably, a selected number of low forward voltage diodes, arranged back-to-back, are included at the input to signal ground of the matching section.

Preferably, the diodes are of Schottky and/or Germanium type.

Preferably, the diodes are DC biased to lower their cut-off voltage range.

Preferably, the receiving antenna arrangement has more than one output, the voltage at each output having approximately the same magnitude. In this arrangement, the signal from each output would pass through separate receive channels which may or may not be identical. Accordingly, the parallel chains of the receiving system have the effect of reducing coupling between components of the antenna arrangement.

Preferably, the receiving antenna includes a coil with two ends, where the signal from each end is approximately equal in magnitude but opposite in polarity relative to a signal ground point located in between the two ends.

Preferably, the isolating means has two differential inputs and two balanced outputs with respect to ground, and the matching section has two differential inputs and a single output relative to ground.

Alternatively, it is preferred that the isolating means has two differential inputs and two balanced outputs with respect to ground, the matching section has two differential inputs and two outputs, and the amplifier has two differential inputs and a single output.

Preferably, the matching section is cooled to obtain improved thermal and shot noise performance.

Preferably, a further damping switch is included from the signal ground to the output of the antenna, the damping switch being triggered by a synchronized pulse to the transmit signal pulse sequence.

In accordance with another aspect of the present invention, there is provided a method for receiving a response signal via an antenna arrangement from a substance having quadrupolar nuclei excited so as to produce nuclear quadrupole resonance in certain of the quadrupolar nuclei, comprising:—
noise matching an amplifier to the antenna and lowering the Q of the antenna system during a receiving period when the response signal may be received by the antenna arrangement, before processing the received signal further.

Preferably, the method includes rapidly removing energy from the antenna at the start of the receiving period.

Preferably, the method includes improving the phase stability of the response signal during the receiving period.

Preferably, the method includes isolating the antenna arrangement during a transmitting period when an excitation signal is transmitted by the antenna to irradiate the substance, and electrically connecting the antenna arrangement to enable noise matching during the receiving period.

In this manner, the method can adopt the cycle of maintaining a high Q on the antenna during the transmitting period, followed immediately by a low Q during the entire receiving period for any data gathering transmit signal pulse sequence in the field irradiating the substance. Thus, as mentioned with the receiving system, the high Q phase allows power delivery into the antenna for efficient excitation over a frequency band, and the low Q during the receiving period allows measurement of signals close in time to the excitation transmit signal pulse. Consequently, this enables a fast accumulation of the response signal to its maximum amplitude, broader frequency bandwidth to receive the response signal or several response signals and vastly improved received signal phase stability. All these features allow for better dynamic SNR measurements during the data collection phase and better selection of a true response signal from other competing signals such as those arising from magneto-acoustic objects or thermal noise.

### BRIEF DESCRIPTION OF THE DRAWINGS

FIG. 1 is a representative diagram of the prior art showing the series connection of an antenna connected to a high voltage isolator then to an amplifier.

FIG. 2 is a representative diagram of prior art showing the same apparatus as in FIG. 1 using a Q switch in between the isolating circuit and antennae.

FIG. 3 is a representative diagram of the prior art showing an amplifier which uses capacitive division to reduce feedback noise.

FIG. 4 is a block diagram showing the general configuration of the receiving system employed in the best mode for carrying out the invention.

FIG. 5 is a circuit diagram of the isolating switch used in each of embodiments.

FIG. 6 is a schematic diagram of the matching section using JFETs in accordance with the first to the sixth embodiments, where the transistors are arranged in a ground gate configuration.

FIG. 7 is a schematic diagram of the alternative arrangement for the isolating section in accordance with the second embodiment.

FIG. 8 is a schematic diagram of the feedback amplifier in accordance with the third embodiment.

FIG. 9 is a schematic diagram of the matching section cooled by cooling units in accordance with the fourth embodiment.

FIG. 10 is a block diagram showing the fifth embodiment and a schematic arrangement of the sixth embodiment of the invention where a low voltage Q-switch has been included after the isolating switch.

FIG. 11 is a schematic diagram of the matching section using FETs in accordance with the seventh to the thirteenth embodiments, where the transistors are arranged in a cascode configuration with an effective cold resistor as the feedback.

FIG. 12 is a block diagram showing the general layout of a configuration that contains a separate Q-switch to remove some energy from the antenna.

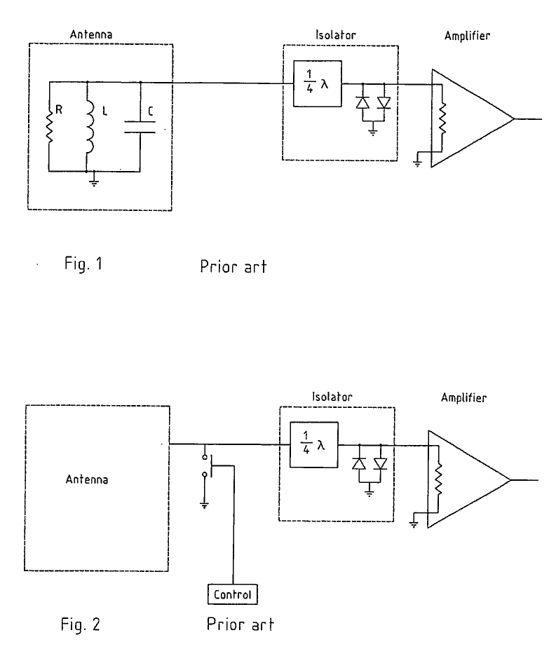

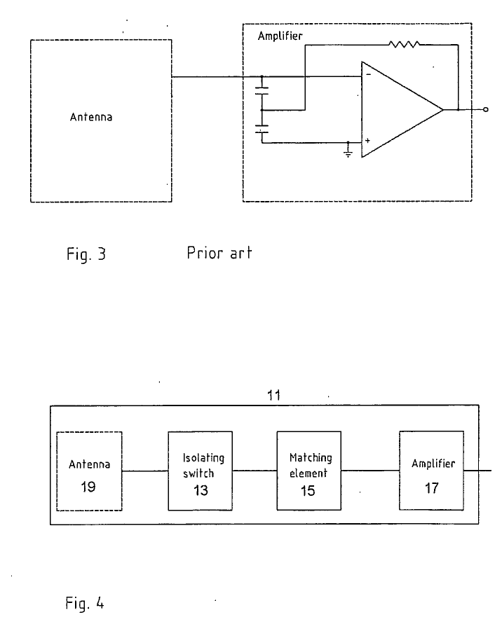

### BEST MODE(S) FOR CARRYING OUT THE INVENTION

The following is a detailed description of the best mode for carrying out the invention, detailing various embodiments of the invention where reference is made to the drawings as appropriate.

The best mode of performing the invention is directed towards a receiving system for detecting response signals emitted from a substance having quadrupolar nuclei that are excited so as to produce nuclear quadrupole resonance, and a method by which the receiving system operates.

The substance containing the quadrupolar nuclei may be excited by various known and evolving techniques involving the transmission of a transmit signal pulse that irradiates the substance. As these techniques are commonly known and are not concerned with the present invention apart from the fact that they involve transmission of a transmit signal pulse, they will not be described in further detail herein. For a detailed explanation of the NQR phenomenon and how substances containing quadrupolar nuclei may be excited, regard should be made to the applicant's corresponding International Patent Application PCT/AU00/0124 (WO 01/25809), which is incorporated herein by reference.

As shown in FIG. 4 of the drawings, the receiving system 11 of the best mode consists of an isolating switch 13, a matching section 15 and an amplifier 17, which is electrically connected to a high quality factor (high Q) antenna arrangement 19.

The high Q antenna arrangement 19 is the same antenna used for excitation of the substance and may be constructed by any means available to those skilled in the art. For example, a solenoid and balance capacitors can be used to form a resonant circuit with the antenna coil, which can detect changes in the magnetic field. The antenna arrangement 19 does not have to be physically attached to the excitation cavity within which the substance is disposed for detection purposes, although for optimum reception of an induced signal, as determined by the reciprocity theorem known in the art, it is the most ideal configuration.

The output voltages or currents of the receiving system 11 contain the amplified analog signals that can be passed into a digitising unit (not shown) for further processing by a computational unit (also not shown) to detect the presence of an NQR signal determinative of the presence of a substance being detected.

The isolating switch 13 comprises an inductive element whose impedance can be changed between two different states. The two states are a high impedance mode set by the inductive element being provided with a high reactance and a low impedance mode set by the same inductive element being provided with a low reactance. This can be achieved a variety of ways, with specific arrangements being subsequently described with respect to specific embodiments of the best mode for carrying out the invention.

The matching section 15 is a thermal noise matching circuit constructed from N repeating semiconductor transistor units. The transistors are chosen to have the lowest noise figure at the source resistance, typical frequency and bias configuration of the antenna arrangement 19.

The choice of semiconductor transistor depends on the source impedance (R) the antenna presents. For Qs of about 200-2000 and frequencies around 1 MHz the source impedance is of the order of 1 kohm. For an intended noise figure below 1.0 dB, a choice exists between bipolar transistors (BJT) and field effect transistors (FETs). Junction FETs (JFET) are preferred because of their excellent low voltage and current noise characteristics and can be readily parallelled to obtain the best noise match to a prescribed source resistance. Bias configurations are chosen to reduce shot noise to a point where its contribution would be negligible.

By considering the equivalent voltage noise (Vₙ) and current noise (Iₙ) of each device, the approximate number (N) of FETs included in the matching section 15 is given by:
N=Vₙ/(IₙR).

The matching section 15 by its nature reduces the input impedance as seen by the coil.

With the FETs in a grounded base configuration, the input impedance Rᵢₙₚᵤₜ for small signals is approximately given by:
Rᵢₙₚᵤₜ=1/(N gₘ),
where gₘ is the transconductance of each FET.

The above approximation assumes a reasonably low (˜1 kohm) output load impedance. The input impedance for several FETs for optimum noise match is between 1-30 ohms, depending on the choice of FETs, biasing elements and currents within the circuit design of the matching section. The effective temperature of the input resistance for well-chosen transistors is less than 0.5 K at a tuning point.

To gain an idea of the effect this would have on controlling the ringing of the antenna, the worst limit of the input impedance being 20 ohms is now described as an example. This reduction in impedance on the antenna would reduce the Q to about 50, giving a decay constant, as calculated from the earlier equation, of 6 μs with f₀=1 MHz. To reduce the ringing level well below the target material's signal level to be received, it is usual to assume this happens within a period of 20 time constants. Thus the input impedance of the matching amplifier 17 has eliminated ringing of the antenna in about 120 μs in the worst case.

In the unmatched system the antenna ringing will persist for approximately 6 ms. This long interval degrades the performance of the receive system not only by the increase in effective dead time, but also by forcing the modification of pulse sequences used in NQR excitation to long delays between transmit pulses.

The effect of the lowered Q can be explored by considering the phase shift produced by a frequency offset from the tuning point. This phase shift φ is given by:
φ=2Q(ω−ω₀)/ω₀,
where ω is the angular frequency of the line close to ω₀, which is the angular center frequency of the antenna. The phase sensitivity is directly proportional to the Q of the antenna.

With the example above, with the Q being reduced from 1000 to 50, the improvement is about a factor of 20 for a particular frequency offset. This is important when further processing of the response signal involves coherent addition or subtraction, phase selection or a phase weighting method for a detection algorithm.

The amplifier 17 according to the best mode of the invention is a standard amplifier with high input impedance. The amplifier 17 is constructed in such a way to have low current and voltage noise characteristics at its input so that it does not add significantly to the level of thermal noise arriving from previous elements. By adopting such an arrangement, the receiving system 11 effectively broadens the bandwidth and lowers the input impedance of the high input impedance amplifier 17.

The matching section 15 necessarily has a low gain of 0.5 to 50 to avoid saturation, so it is usually required to follow-up with a high gain amplifier 17 to produce a signal of sufficient magnitude to be acquired above the digital noise of an ADC (analog to digital converter) in the digitising unit (not shown).

Thus, the amplifier 17 in the best mode has an excellent noise figure, with gains of greater than 100. In practice, the amplifier unit 17 could be separated into several stages of gain, or integration, and possess feedback elements to set desired low noise input characteristics.

The best mode for carrying out the invention will now be described with respect to several embodiments. In accordance with the first embodiment, the isolating switch 13 comprises a low loss RF transformer controlled by a control circuit, the matching section 15 comprises a plurality of grounded gate JFETs (junction field effect transistors) connected in parallel, and the amplifier 17 comprises a high input impedance amplifier.

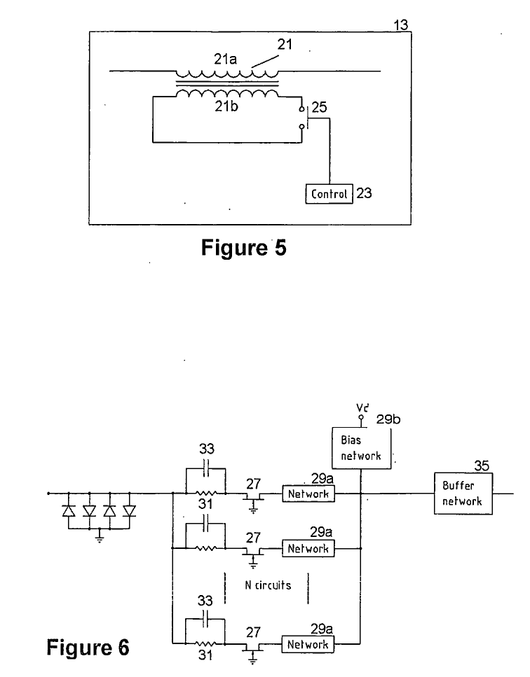

The arrangement of the isolating switch is as shown in FIG. 5, wherein a low loss RF transformer 21 with primary and secondary coils wound on a low-loss, high permeability material is provided. The primary side 21a of the transformer forms the series circuit to the signal receiving system 11 and the secondary side 21b is either opened or closed circuit to actuate a change in reactance and hence impedance, by virtue of a control circuit 23 and switch 25.

The isolating switch 13 does not conduct significant currents in its open state and is able to close after the transmission of the transmit signal pulse to excite the quadrupolar nuclei of the substance, so as to provide a low impedance path, well below the input impedance of the matching section 15. The control circuit 23 of the isolating switch 13 in the present embodiment uses an external control signal from a computer or timing electronics, which is synchronised to the transmit signal pulse of the excitation circuit. This control signal triggers the switch 25 to a closed position for a specified duration, which overlaps with the receiving period of the receiving system 11.

With the isolating switch 13 closed, the signal from the antenna 19 will arrive at the noise matching section 15. The aim of the matching section 15 is to optimise the signal-to-noise bandwidth of the receive system 11 in a circuit configuration that presents a low load impedance to the antenna 19. This lowered impedance at the input of the matching section 15 will significantly reduce the Q of the antenna 19. The reduced Q has three main beneficial effects, firstly to increase the bandwidth of the receiver system, secondly to efficiently remove stored energy in the antenna and thirdly provide for increased stability in the response signal receiving phase. This can be contrasted with the prior art where a typical high Q antennae system would saturate the amplifier for several milliseconds.

According to the present embodiment of the invention, the matching section 15 is shown in FIG. 6. This figure shows repeated units of grounded gate JFETs 27 and bias network elements 29a, arranged in parallel.

In the construction of a matching section according to this embodiment, special attention is paid to minimizing the Miller effect (capacitive amplification of noise), and having an effective cold resistive input to signal ground. The noise match to the antenna 19 determines the number of units at a chosen bias point. The device choice largely determines a suitable bias network. With an appropriate device the bias network can be simplified to very few if any electrical components. The reduction in components is generally useful in making the section broad-band. In this construction, on the drain side of each unit 27, a low value resistor 31 to set the operating point is bypassed by a capacitor 33 to minimize its series resistance to the high frequency signal. The JFETs 27 are readily biased through a simple network 29a and 29b that may consist of a broad band-tuning element.

The bias voltages across the FET leads are kept low so as to reduce current noise from junction leakage currents. The bias level is traded-off to some extent with the amount of source-drain current, which also sets the transconductance of each device 27. Ideally the FETs 27 are chosen to have identical characteristics and have the best figure of merit (equal to gₘ/2πCⱼ where Cⱼ is the junction capacitance).

The matching section 15 of the present embodiment has a buffer network 35, as shown in the figure, which isolates the matching section from the following amplifier stage 17. This buffer network 35 may be as simple as a capacitor.

The second embodiment is substantially identical to the first embodiment, except that the isolating switch 13 arrangement is replaced by a control which monitors the transmit signal of the excitation circuit, triggering an open state once the transmit signal level rises beyond a specified level, and closing once the transmit level falls below a specified level. This scheme has the advantage of being self-protecting and automatically safeguards the following electronics from high voltages developed on the antenna via an incorrectly timed trigger pulse which could arise in the isolating switch arrangement of the first embodiment.

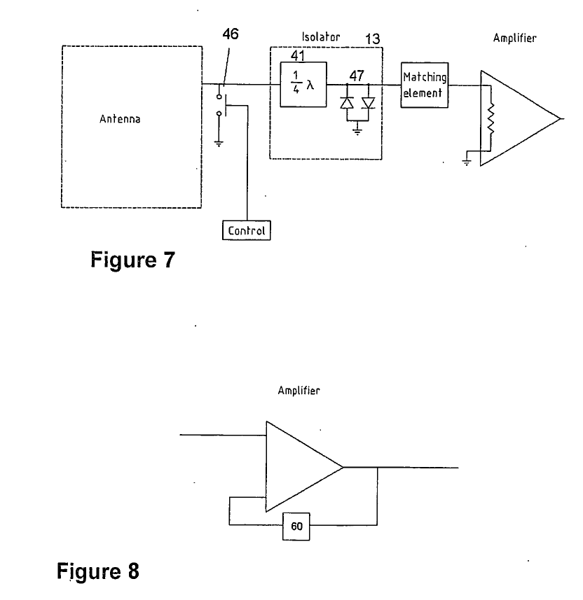

An example of the second embodiment is shown in FIG. 7, where the isolating switch 13 uses a quarter wave line 41 in place of the transformer 21, having an end 43 that is made a node or anti-node via opening or closing a conducting element 46. In this example, the ¼ wave line end 43 is terminated by back-to-back signal diodes 47, which automatically open and close depending on the level of the transmit signal sensed by the control 23.

The third embodiment is substantially identical to the first or second embodiments, except that the amplifier 17 is replaced by a feedback amplifier whose intention is to lower its input impedance without introducing noise from a resistive feedback circuit element, as shown in FIG. 8. The network box 60 could be a resistor, capacitor or a series of circuits which create a feedback amplifier.

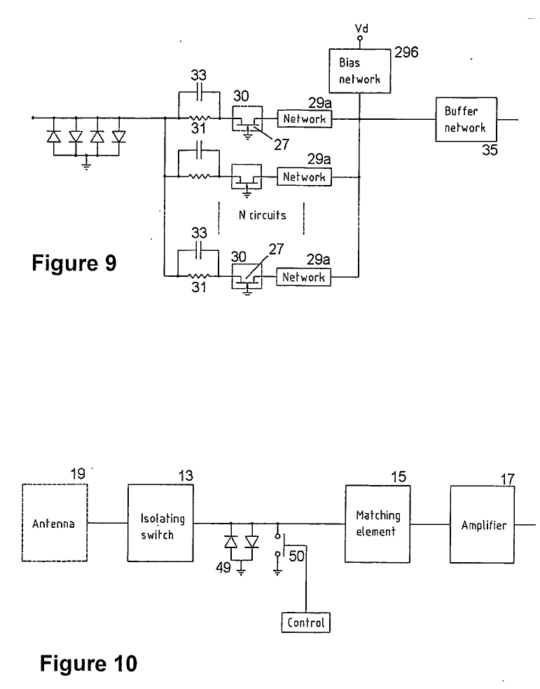

The fourth embodiment is substantially identical to the first or second embodiments, except that in this embodiment the matched section 15 is cooled, as shown in FIG. 9. This is accomplished through a Peltier unit 30 where the cold side is attached to the JFETs 27. Lowering the temperature below room temperature decreases the shot noise of the device. To significantly reduce the thermal noise of the matching section, further cooling is required by using a recirculating refrigeration system.

The fifth embodiment is substantially identical to the first, second, third or fourth embodiments, except that in this embodiment damping means in the form of back-to-back signal protection diodes are added. As mentioned previously, just after the isolation switch 13 has been closed there is significant energy left in a high Q antenna. The matching section 15 is likely to be saturated by this energy, tending towards a higher input impedance during this period. As shown in FIG. 10, to avoid saturation and damage, back-to-back protection signal diodes 49 are added, connected from the signal input to signal ground. Diodes 49 in such a configuration clip the input signal above this cut-off voltage, the overall current flow through them being dependent on the chosen diodes.

The diode type is chosen for its low forward voltage and steep 1V curves, so as to have as low as possible cut-off voltage (typically less than 0.3V) and as high as possible real resistance (>10 kohms) while not conducting. Some types of diodes that would be useful in this role are Germanium and Schottky style diodes.

The diode back-to-back pairs 49 are parallelled to reduce the cutoff voltage to some degree or are controllably biased with a DC voltage to reduce the effective voltage band over which they do not conduct.

In this embodiment the matching section's input impedance is maintained below a low value, through the range of input voltages. The diodes at the input are selected carefully so that their forward voltages allow the matching amplifier 17 to always present low impedance, without introducing excessive noise. These diodes 49, as described previously, are in the back-to-back configuration at the input. At the voltage where the diodes no longer conduct significantly, the matching section 15 is able to maintain low input impedance to lower input voltages. Schottky diodes have found to be the best diodes for this purpose.

In the sixth embodiment, which is substantially identical to the first, second, third, fourth or fifth embodiments, saturation is avoided by including a semiconductor clamping switch at the input of the matching stage, to signal ground. As represented by the damping switch 50 in FIG. 10 of the drawings, the clamping switch is closed for a certain length of time to draw energy from the antenna and reduce voltages to a sufficient level, after the isolation switch is closed. The opening of this clamping switch is controlled so as not to re-excite the antenna 17. The clamping switch is also arranged so as not to allow the control signal to re-excite the antenna.

An example of the present embodiment involves the clamping switch comprising a low gate to drain capacitance MOSFET or paralleled MOSFETs device, the gates being driven to increase conduction by a shaped control signal.

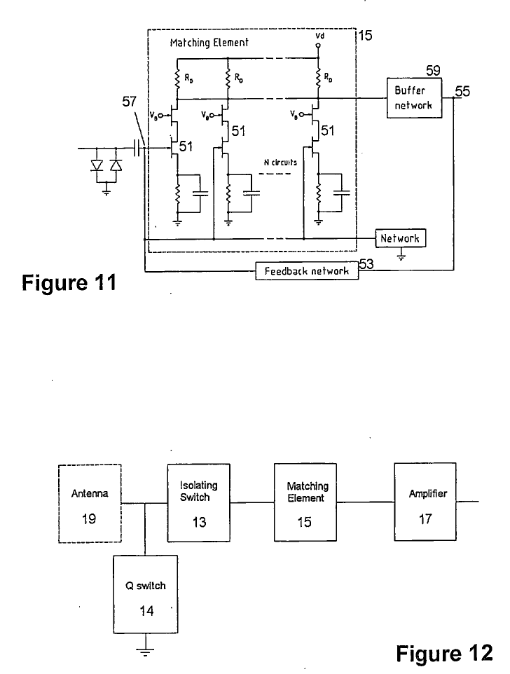

The seventh to the thirteenth embodiments are substantially identical to the first to the sixth embodiments, except that the JFETs in the matching section 15 are replaced by FETs. As shown in FIG. 11, FETs 51 are arranged in a cascode fashion.

In these embodiments, as previously mentioned in the first embodiment, the matching section 15 has N repeating elements of the transistor network to obtain a close noise match to the antenna's effective parallel resistance. For a FET cascode embodiment, the input impedance is large, but can be readily lowered through a negative feedback network 53 from the output terminal 55 to the input terminal 57 of the matching section 15.

In this case care must be taken to ensure that noise from the feedback network 53 does not reach the input of the amplifier 17. This embodiment uses resistive feedback where the feedback network 53 reduces the thermal noise from this resistance delivered to the input 57 of the matching section 15. In other words a feedback network 53 is provided that acts like a “cold resistor”.

An example of this “cold resistor” network 53 is a series circuit where the resistance is followed by an operational amplifier (not shown) with a capacitor (not shown) providing negative feedback to act as an integrator, the output of this integrator then connecting to the input of a differentiating circuit (not shown). The differentiating circuit could be as simple as a capacitor. The output of the differentiating circuit is then connected to the input of the matching section to form the closed feedback loop.

The buffer network 59 as shown in FIG. 11 would separate out the DC bias of the output from the FET stages 51, so it maybe as simple as a capacitor.

Another arrangement would have a more complicated buffer network 59 to provide extra gain and phase correction

The resistors R_{D} control the open loop gain of the FET stage 51. The upper FETs in the cascode would not necessarily be the same as the lower FETs, in fact in the preferred arrangement of this embodiment, the upper figure-of-merit FET would have a higher I_{dss} than the lower FET in each pair.

It should be appreciated that the current embodiments could be used in conjunction with other introduced damping means. As an example, as shown in FIG. 7 the damping of the circuit is partly affected by a separate controllable switch 46 connected from the antenna signal lead or leads to signal ground. A general example is shown in FIG. 12. These embodiments, 14 through 26 would be substantially identical to embodiments 1 through 13, with a damping method or methods that would act to remove some energy from the antenna prior to the isolating element opening to allow damping to continue though the matching section. An example of this method would be a Q-switch from the antenna output to signal ground, enacted by a semi-conducting device such as a suitable high voltage triac. Another example of damping is through a method of removing energy from the antenna through the power amplifier immediately after the exciting period. In this example, some energy is removed in a short period where the transmit signal is 180 degrees out-of-phase to the excitation driving signal that preceded it in time.

It should be appreciated that the scope of the present embodiment is not limited to the particular embodiments described herein, and that other embodiments of the invention may be envisaged that do not depart from the scope nor the spirit of the invention.

1. A receiving system for connection to an antenna arrangement for detecting response signals from a substance having quadrupolar nuclei excited so as to produce nuclear quadrupole resonance therein, the system comprising:—
an amplifier to amplify the received response signal for subsequent processing; and
a matching section to match the amplifier to the antenna;
wherein the matching section: includes a noise matching circuit to closely noise matches the receiving system to the antenna during a receiving period; and has a low impedance to reduce the Q factor of the antenna without significantly degrading the signal to noise ratio.

2. A receiving system as claimed in claim 1, wherein the matching section presents an effective lower impedance to the antenna.

3. A receiving system as claimed in claim 1, wherein said matching section comprises a damping means to damp stored transmitter energy from the antenna, without effecting further switching or configuration changes.

4. A receiving system as claimed in claim 1, including isolating means to selectively isolate the antenna from the receiving system; the isolating means including switching means to isolate the receiving system from the antenna during a transmitting period when an excitation signal is transmitted by the antenna to irradiate the substance, and to electrically connect the receiving system to the antenna during the receiving period immediately after the transmitting period.

5. A receiving system as claimed in claim 4, wherein the isolating means is interposed between the antenna and the matching section to block the high voltage that may be generated on the antenna during the transmitting period.

6. A receiving system as claimed in claim 4, wherein the isolating means includes ¼ wave lines terminated with back to back diodes to provide isolation, in combination with nodes being set close to the amplifier by protection diodes.

7. A receiving system as claimed in claim 4, wherein the isolating means operates through a pi-network that is equivalent to a ¼ wave line in operation, terminated with back-to-back diodes.

8. A receiving system as claimed in claim 4, wherein the isolating means operates on a change of inductance from a high value to a low value of impedance during the switching process, the low value of the isolating means having impedance that is less than the characteristic input impedance of the matching section.

9. A receiving system as claimed in claim 4, wherein the isolating means is auto-switching, triggered by monitoring electronically an increase or decrease in input signal level beyond a threshold level.

10. A receiving system as claimed in claim 4, wherein the isolating means is auto-switching, triggered by a second input that monitors electronically an increase or decrease in signal from the transmitter unit output.

11. A receiving system as claimed in claim 4, wherein the isolating means is triggered by a reproducible electrical signal which is synchronised to the transmit sequence.

12. A receiving system as claimed in claim 4, wherein the switching means has opening and closing characteristics shaped in time.

13. A receiving system as claimed in claim 4, wherein the switching means is not frequency dependent over the general range of NQR lines of interest.

14. A receiving system as claimed in claim 4, wherein said isolation means is followed by a low impedance signal receive circuit that reduces energy in the antenna and remains in the low impedance state during the entire receiving period.

15. A receiving system as claimed in claim 1, wherein said matching section is constructed from high figure-of-merit transistors to create a close to ambient temperature thermal noise match to the antenna.

16. A receiving system as claimed in claim 1, wherein an additional low impedance, low voltage high-speed semiconductor switch is included after said isolation means to function as a damping switch.

17. A receiving system as claimed in claim 16, wherein said damping switch has predetermined transition rates so as not to re-excite the antennae through parasitic capacitance or changes in state.

18. A receiving system as claimed in claim 16, wherein the damping switch is transistor based and is included at the input of the matching section to controllably lower the input resistance to signal ground, the damping switch being driven by a pulse synchronised to the transmit sequence.

19. A receiving system as claimed in claim 16, wherein the damping switch is based on a FET or parallel FETs pulse triggering the gate or gates.

20. A receiving system as claimed in claim 16, wherein the damping switch is based on a MOSFET or parallel MOSFETs where the source and drain are connected from the signal input to ground, and that a pulse to the gate triggers the damping switch.

21. A receiving system as claimed in claim 16, wherein the turning on and off characteristics of the damping switch are controlled through time.

22. A receiving system as claimed in claim 1, wherein the matching section comprises transistors that are JFETs arranged in parallel source and drain connections with their gates at signal ground.

23. A receiving system as claimed in claim 1, wherein the matching section comprises a plurality of JFET transistors arranged in a cascode arrangement with a negative feedback circuit.

24. A receiving system as claimed in claim 23, bipolar transistors are provided at the source connection of the JFETs.

25. A receiving system as claimed in claim 23, wherein the negative feedback circuit is equivalent to a cold resistor.

26. A receiving system as claimed in claim 23, wherein the negative feedback circuit is a capacitor or inductor combination.

27. A receiving system as claimed in claim 23, wherein the negative feedback circuit is resistive with most of the fed-back current being conveyed away from the signal input to signal ground through a capacitive or inductive divider.

28. A receiving system as claimed in claim 1, wherein the bandwidth of the matching section is limited in gain by a tuned circuit.

29. A receiving system as claimed in claim 28, wherein the chosen bandwidth would typically lie in a range from 1 kHz to 200 kHz.

30. A receiving system as claimed in claim 1, wherein the amplifier is of negative feedback with a low noise figure.

31. A receiving system as claimed in claim 30, wherein the voltage is fed-back through a negative feedback circuit that is equivalent to a cooled resistor.

32. A receiving system as claimed in claim 31, wherein the feedback circuit is resistive with most of the fed-back current being diverted away from the signal input through a capacitive or inductive divider.

33. A receiving system as claimed in claim 1, wherein a selected number of low forward voltage diodes, arranged back-to-back, are included at the input to signal ground of the matching section.

34. A receiving system as claimed in claim 33, wherein the diodes are of Schottky and/or Germanium type.

35. A receiving system as claimed in claim 33, wherein the diodes are DC biased to lower their cut-off voltage range.

36. A receiving system as claimed in claim 1, including an antenna arrangement having more than one output, the voltage at each output having approximately the same magnitude.

37. A receiving system as claimed in claim 36, wherein the signal from each output passes through separate receive channels that are identical.

38. A receiving system as claimed in claim 36, wherein the signal from each output passes through separate receive channels that are not identical.

39. A receiving system as claimed in claim 36, wherein the receiving antenna includes a coil with two ends, where the signal from each end is approximately equal in magnitude but opposite in polarity relative to a signal ground point located in between the two ends.

40. A receiving system as claimed in claim 4, wherein the isolating means has two differential inputs and two balanced outputs with respect to ground, and the matching section has two differential inputs and a single output relative to ground.

41. A receiving system as claimed in claim 36, wherein the isolating means has two differential inputs and two balanced outputs with respect to ground, the matching section has two differential inputs and two outputs, and the amplifier has two differential inputs and a single output.

42. A receiving system as claimed in claim 36, wherein a further damping switch is included from the signal ground to the output of the antenna, the damping switch being triggered by a synchronized pulse to the transmit signal pulse sequence.

43. A receiving system as claimed in claim 1, wherein the matching section is cooled to obtain improved thermal and shot noise performance.

44. A method for receiving a response signal via an antenna arrangement from a substance having quadrupolar nuclei excited so as to produce nuclear quadrupole resonance in certain of the quadrupolar nuclei, comprising: noise matching an amplifier to the antenna and lowering the Q factor of the antenna system during a receiving period when the response signal may be received by the antenna arrangement, before processing the received signal further.

45. A method as claimed in claim 44, wherein the noise matching is achieved by presenting an effective lower impedance to the antenna.

46. A method as claimed in claim 44, including damping stored transmitter energy from the antenna, without effecting further switching or configuration changes.

47. A method as claimed in claim 46, wherein said damping includes rapidly removing energy from the antenna at the start of the receiving period.

48. A method as claimed in claim 44, including improving the phase stability of the response signal during the receiving period.

49. A method as claimed in claim 44, including isolating the antenna arrangement during a transmitting period when an excitation signal is transmitted by the antenna to irradiate the substance, and electrically connecting the antenna arrangement to enable thermal noise matching during the receiving period.

50. A method as claimed in claim 49, wherein the isolating includes blocking the high voltage that may be generated on the antenna during the transmitting period.

51. A method as claimed in claim 49, wherein the isolating operates on changing the inductance of the from a high value to a low value of impedance during the switching process, the low value having impedance that is less than the characteristic input impedance of the matching.

52. A method as claimed in claim 44, including the cycle of maintaining a high Q on the antenna during the transmitting period, followed immediately by a low Q during the entire receiving period for any data gathering transmit signal pulse sequence in the field irradiating the substance.

53. A system for connection to an antenna arrangement for receiving and detecting response signals from a substance having quadrupolar nuclei excited so as to produce nuclear quadrupole resonance therein, the system comprising:—
means for amplifying the received response signal for subsequent processing;
means for noise matching the amplifier to the antenna during a receiving period; and
means for reducing the Q factor of the antenna during the receiving period without significantly degrading the signal to noise ratio.

54. A receiving system as claimed in claim 1, wherein said noise matching circuit has the lowest noise figure close to the source resistance of the antenna arrangement.
